(19) United States
(12) Patent Application Publication
(10) Pub. No.: US 2024/0083344 A1
(43) Pub. Date: Mar. 14, 2024

(54) VEHICLE LIGHTING DEVICE

(71) Applicant: HONDA MOTOR CO., LTD., Tokyo (JP)

(72) Inventors: Masayoshi TAKORI, Saitama (JP); Yuji TSUCHIYA, Saitama (JP)

(21) Appl. No.: 18/465,170

(22) Filed: Sep. 12, 2023

(30) Foreign Application Priority Data
Sep. 14, 2022 (JP) 2022-146601

(51) Int. Cl. B60Q 1/08

(52) U.S. Cl. CPC B60Q 1/085; B60Q 2300/05; B60Q 2300/114

(57) ABSTRACT

A vehicle lighting device is provided which causes a phenomenon whereby bright areas of an irradiation pattern seem to flow on the roadside of the road, and can give a psychological effect prompting a change in vehicle speed to drivers. A vehicle lighting device includes: a pattern irradiation part which irradiates an irradiation region on a side of a travel path of one's own vehicle by a bright/dark mixed irradiation pattern in which bright regions and dark regions are alternately repeated; a situation recognition device which recognizes a situation prompting a deceleration action or acceleration action to a driver of one's own vehicle, and obtains an output corresponding to the recognition; and a controller which controls the pattern irradiation part so that bright regions and dark regions of the pattern irradiation light move in a front/rear direction of the vehicle, based on the output of the situation recognition device.

This application is based on and claims the benefit of priority from Japanese Patent Application No. 2022-146601, filed on 14 Sep. 2022, the content of which is incorporated herein by reference.

### BACKGROUND OF THE INVENTION

### Field of the Invention

The present invention relates to a vehicle lighting device.

### Related Art

In a location such that a so-called sag section where a road changes from downhill to uphill, there is a tendency for the driver of a vehicle to naturally slow down the vehicle speed, and this becomes a cause for traffic jams. Conversely, when passing this sag section, there seems to be a tendency for drivers to raise the vehicle speed excessively. As a measure to eliminate such traffic jams, and suppress excessive vehicle speed, an infrastructure may be developed to cause a phenomenon whereby bright areas seem to flow by sequentially turning on a series of light emitting units arranged at predetermined intervals on the road side, and give a driver a psychological effect that prompts a change in vehicle speed. In this case, in order to prompt adjustment of vehicle speed without the driver losing attention of the overall travel direction, a technique of dimming the light emitting units to match the brightness of the surroundings has been proposed (for example, refer to Patent Document 1).
Patent Document 1: Japanese Unexamined Patent Application, Publication No. 2013-159915

### SUMMARY OF THE INVENTION

However, with such a technique in Patent Document 1, the infrastructure to be developed for eliminating traffic jams and suppressing excessive vehicle speed becomes large scale. For this reason, even if a highway or similar road, it is only possible to develop this type of infrastructure at limited locations.

The present invention has been made taking account of the aforementioned such situation, and has an object of providing a vehicle lighting device which causes a phenomenon whereby bright areas of an irradiation pattern seem to flow on the roadside of the road without needing infrastructure development on the side of the road, and can give a psychological effect prompting a change in vehicle speed to drivers.

A vehicle lighting device according to a first aspect of the present invention includes: a pattern irradiation part (for example, the projector unit 8 described later) which irradiates an irradiation region on a side of a travel path of one's own vehicle by a bright/dark mixed irradiation pattern (for example, the rhombus lattice irradiation pattern 15, stripe irradiation pattern 21 described later) in which bright regions (for example, the bright region 13 described later) and dark regions (for example, the dark region 14 described later) are alternately repeated; a situation recognition device (for example, the situation recognition device 50 described later) which recognizes a situation prompting a deceleration action or acceleration action to a driver of one's own vehicle, and obtains an output corresponding to the recognition; and a controller (for example, the lamp control ECU 9 described later) which controls the pattern irradiation part so that bright regions and dark regions of the pattern irradiation light move in a front/rear direction of the vehicle, based on the output of the situation recognition device.

According to a second aspect of the present invention, in the vehicle lighting device as described in the first aspect, the controller controls the pattern irradiation part so as to change a speed at which the bright regions and dark regions of the irradiation pattern move.

With the vehicle lighting device of the first aspect, the situation recognition device recognizes as having reached a situation where prompting a deceleration action or acceleration action to the driver of one's own vehicle is required, and emits an output corresponding to this recognition. In response to this output, a controller controls the pattern irradiation part so that the bright regions and dark regions of the pattern irradiation light move in the front/rear direction of the vehicle. For this reason, the driver is prompted by the flow of the irradiation pattern from the pattern irradiation part, and is guided to an action of accelerating or decelerating the vehicle.

With the vehicle lighting device of the second aspect, based on the output corresponding to recognition of the situation recognition device, the controller controls the pattern irradiation part so as to change the speed at which the irradiation pattern of irradiation light moves in the front/rear direction of the vehicle. For this reason, the driver perceives the change in speed of flow of the irradiation pattern, and is prompted to adjust the vehicle speed so as to become the appropriate degree.

### BRIEF DESCRIPTION OF THE DRAWINGS

FIG. 1 is a schematic view showing an aspect of irradiation of illumination light by a vehicle lighting device according to an embodiment of the present invention;

FIG. 2 is a block diagram of the vehicle lighting device according to an embodiment of the present invention;

FIG. 3 is a view showing an irradiation region of each lamp in the vehicle lighting device in FIG. 2;

FIG. 4 is a view showing the irradiation region of a lamp corresponding to a case in which an operation mode of the vehicle lighting device in FIG. 2 is a low-beam mode;

FIG. 5 is a view showing an example of an irradiation region of a lamp in a case in which the operation mode of the vehicle lighting device in FIG. 2 is high-beam mode;

FIG. 6 is a view showing an example of an irradiation pattern by a pattern irradiation part of the vehicle lighting device in FIG. 2;

FIG. 7 is a view showing an aspect of a driver field of view at night irradiated by the vehicle lighting device of FIG. 2; and

FIG. 8 is a timing chart showing operation of the vehicle lighting device in FIG. 2; and

FIG. 9 is a view showing another example of an irradiation pattern by the pattern irradiation part in the vehicle lighting device of FIG. 2.

### DETAILED DESCRIPTION OF THE INVENTION

Hereinafter, an embodiment of the present invention will be explained while referencing the drawings. It should be noted that, in the following explanation, irradiation region is the irradiation area of light by the lamp, and irradiation pattern is a design by a bright region and dark region of the irradiation region, contour shape of the irradiation region, and other irradiation forms.

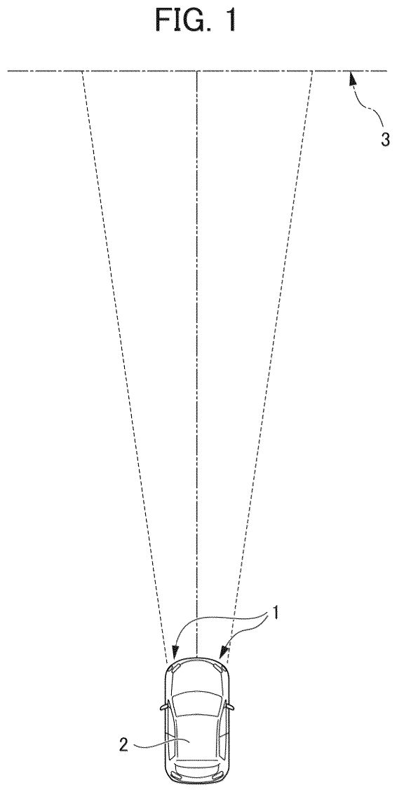

FIG. 1 is a schematic view showing an aspect of irradiation of illumination light by a vehicle lighting device 1 according to an embodiment of the present invention. Ahead of the front of the vehicle lighting device 1 provided to a vehicle 2, for example, the distribution of irradiation light from the vehicle lighting device 1 is evaluated by an irradiation pattern formed on a test screen 3, which is a predetermined virtual vertical plane established 25 m ahead.

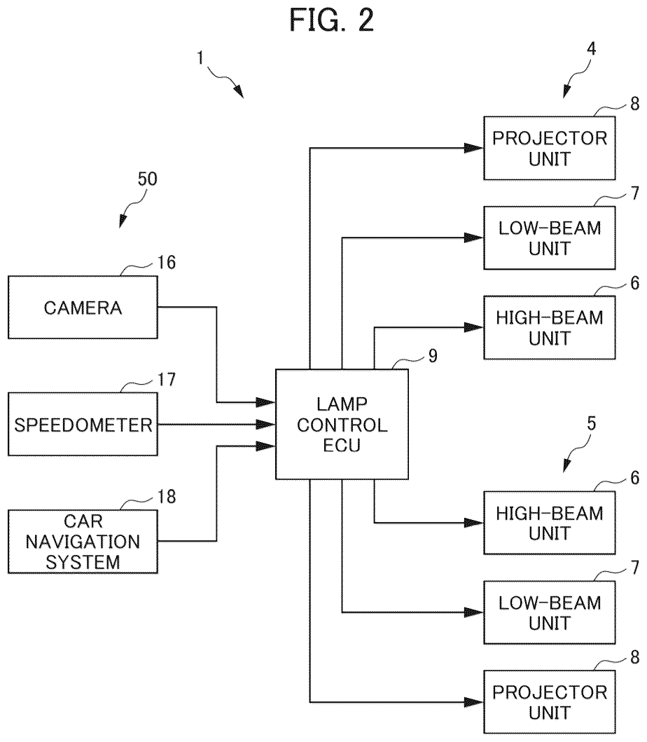

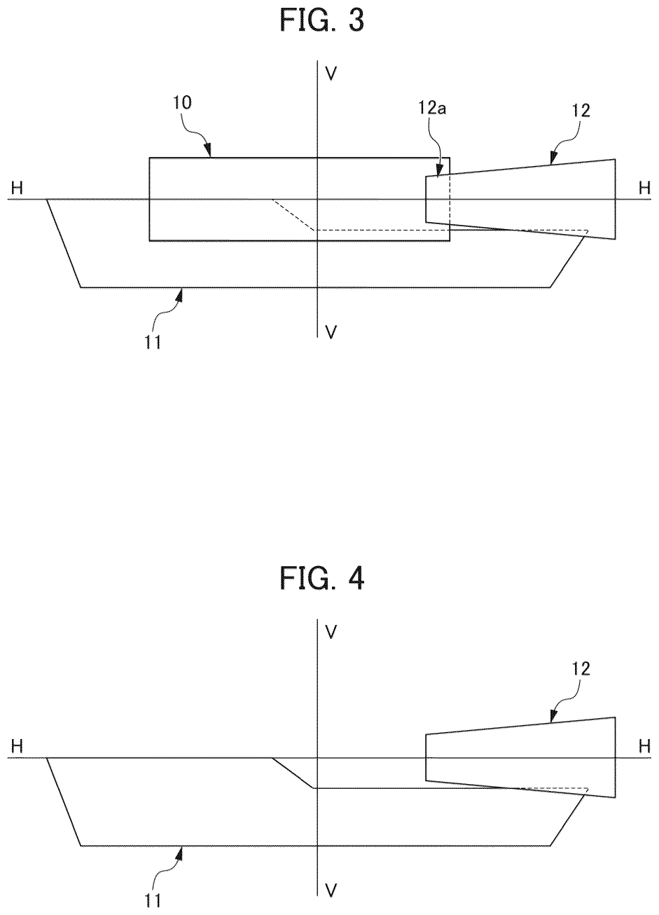

FIG. 2 is a block diagram of the vehicle lighting device 1, and FIG. 3 is a view showing the irradiation region of each lamp of the vehicle lighting device 1. At each of a left-side headlight unit 4 and right-side headlight unit 5 which are lamps, a high-beam unit 6, low-beam unit 7 and projector unit 8 are arranged in order from the inner side to the outer side in the vehicle-width direction of the vehicle 2. In each of the left-side headlight unit 4 and right-side headlight unit 5, the high-beam unit 6, low-beam unit 7 and projector unit 8 operate under the control of a lamp control ECU 9.

The high-beam unit 6 includes a light emitting element which is the light source, a light shield which defines the irradiation region and a lens. The light emitting element generates light by electric power being supplied from a power source (not shown), in response to a control signal from the lamp control ECU 9. The light from the light emitting element is reflected by the reflector. The reflected light from the reflector is irradiated from the lens toward a high-beam irradiation region 10 defined by the light shield.

The low-beam unit 7 includes a light emitting element which is a light source, a reflector, a light shield which defines the irradiation region, and a lens. The light emitting element generates light by electric power being supplied from a power source (not shown), in response to a control signal from the lamp control ECU 9. The light from the light emitting element is reflected by the reflector. The reflected light from the reflector is irradiated from the lens towards the low-beam irradiation region 11 defined by the light shield.

The projector unit 8 includes a light emitting element which is a light source, a spatial light modulator and a lens. As the spatial light modulator, for example, it is possible to utilize one of a form which reflects light, while independently modulating the several reflecting elements as in a DMD (Digital Micromirror Device). In this case, the projector unit 8 assumes a configuration of a DLP (Digital Light Processing: registered trademark) system using DMD, and can irradiate light in various predetermined irradiation patterns from the lens to the front of the vehicle 2 and its surroundings.

The irradiation pattern can also assume not only still image patterns of various shapes, but also the form of a video pattern. The light emitting element generates light by driving electric power being supplied from a power source (not shown) in response to a control signal from the lamp control ECU 9. The light from this light emitting element is spatially modulated by the spatial light modulator driven according to the control signal from the lamp control ECU 9, and light is irradiated from the lens of the projector unit 8 in various predetermined irradiation patterns in front of the vehicle 2 and the surroundings thereof. In other words, the projector unit 8 configures a pattern irradiation part which irradiates the irradiation light in a lateral irradiation region on the side of the travel path of the vehicle 2 in the bright/dark mixed irradiation pattern in which a bright region and dark region are alternately repeated.

By referencing FIG. 3, the irradiation region by the high-beam unit 6, low-beam unit 7 and projector unit 8 will be explained in the case of irradiating light on the test screen 3 from the vehicle lighting device 1 of FIG. 1. Herein, regarding the irradiation region by the projector unit 8, the irradiation region by the projector unit 8 of the right-side headlight unit 5 is shown.

The irradiation region by the projector unit 8 of the left-side headlight unit 4 is symmetrical with the irradiation region by the projector unit 8 of the right-side headlight unit 5 with the line V-V as the axis of symmetry.

The configuration and operation of the projector unit 8 of the left-side headlight unit 4 are similar to the projector unit 8 of the right-side headlight unit 5. For this reason, the configuration and operation of the projector unit 8 of the left-side headlight unit 4 invoke the explanations for the projector unit 8 of the right-side headlight unit 5.

The low-beam irradiation region 11 by the low-beam unit 7 has an oncoming-lane side cutoff line extending in parallel to a line H-H (horizontal line) more to the right side than the line V-V (vertical line) at the center in the left/right direction on the test screen 3. In addition, it has an own-lane side cutoff line extending along the line H-H at a higher position than the oncoming-lane side cutoff line. Both the oncoming-lane side cutoff line and own-lane side cutoff line are linked by an oblique cutoff line which slopes relative to the line H-H. The low-beam irradiation region 11 is a lower irradiation region on the front lower side of the vehicle 2.

The high-beam irradiation region 10 by the high-beam unit 6 forms a rectangle having a long side parallel to the line H-H and a short side parallel to the line V-V, and an intersection of their diagonals occupy a position substantially matching the intersection of the line H-H and line V-V. The high-beam irradiation region 10 overlaps the low-beam irradiation region 11 in a lower partial region including a portion more to the line V-V of each of the oncoming lane side cutoff line and the own-lane side cutoff line. The high-beam irradiation region 10 is an upper irradiation region more upwards than the low-beam irradiation region 11, which is the lower irradiation region, and more to the central side in the vehicle-width direction of the vehicle 2.

In the right-side pattern irradiation region 12, which is the irradiation region by the projector unit 8 of the right-side headlight unit 5, the irradiation pattern variously changes such as the contour shape of the region and the form of the irradiation pattern within this region, according to the mode switching signal from the lamp control ECU 9. However, the right-side pattern irradiation region 12 is a lateral irradiation region on the travel path side of the vehicle 2, even in the case of assuming the any form of irradiation pattern.

Concerning the ability of the projector unit 8, the right-side pattern irradiation region 12 can assume a wide form including an overlap region 12a which overlaps with the high-beam irradiation region 10. In the case of assuming this form, the right-side pattern irradiation region 12 makes a trapezoidal shape in a landscape orientation in which the height direction is parallel to the line H-H, and the upper base and lower base are parallel to the line V-V. This trapezoid is longer at the lower base which is relatively far from the line V-V than the upper base which is relatively close to the line V-V. In other words, the right-side pattern irradiation region 12 makes a shape in which the dimension along the line V-V towards the outer side in the vehicle width direction of the vehicle 2 widens.

The lamp control ECU 9 switches the operation mode of the vehicle lighting device 1, based on the output from a higher-order ECU, light switch, light switch lever, which are not shown, and camera 16 described later, equipped to the vehicle 2. In other words, the lamp control ECU 9 supplies a control signal to the high-beam unit 6, low-beam unit 7 and projector unit 8, and switches the operation mode of each of these units.

FIG. 4 is a view showing the irradiation region of irradiation light by the vehicle lighting device 1, in the case of the operation mode according to the lamp control ECU 9 being set to the low-beam mode. At night, when the light switch is in the position of “auto”, and the light switch lever is at a position other than low beam, the vehicle lighting device 1 is often in the state of high-beam mode. In this state, when the camera 16 detects oncoming vehicles, ahead vehicles or a certain number of street lights, the operation mode of the vehicle lighting device 1 switches to the low-beam mode by the lamp control ECU 9. During low-beam mode, the high-beam unit 6 is turned off under the control by the lamp control ECU 9, the low-beam unit 7 irradiates the low-beam irradiation region 11, and the projector unit 8 irradiates the right-side pattern irradiation region 12.

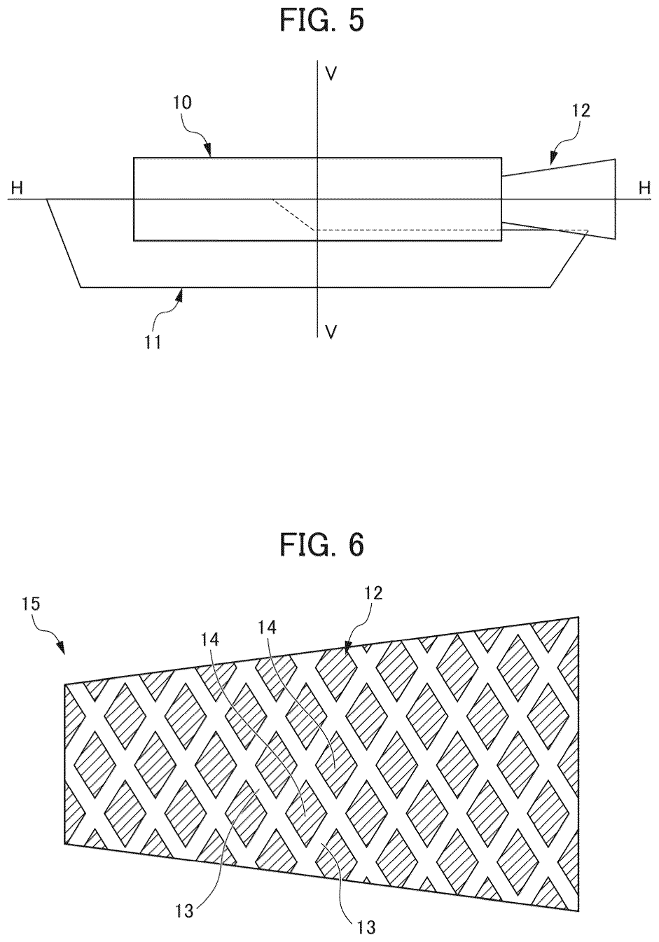

FIG. 5 is a view showing an irradiation region of irradiation light by the vehicle lighting device 1 in the case of the operation mode according to the lamp control ECU 9 being set to high-beam mode. When the light switch is at the “auto” position at nighttime, and the light switch lever is at a position other than high beam, the vehicle lighting device 1 is often in the state of high-beam mode. In this state, in the case of the camera 16 not detecting an oncoming vehicle or ahead vehicle, or at least a certain number of street lights, the operation mode of the vehicle lighting device 1 is switched to high-beam mode by the lamp control ECU 9. In detail, the vehicle 2 being during travel at a speed of at least 30 km per hour, for example, being detected by the higher-order ECU is said to be a necessary condition for switching to the high-beam mode. During high-beam mode, the high-beam unit 6 irradiates the high-beam irradiation region 10, the low-beam unit 7 irradiates the low-beam irradiation region 11, and the projector unit 8 irradiates the right-side pattern irradiation region 12, under control by the lamp control ECU 9.

During high-beam mode, the shape of the irradiation pattern of the right-side pattern irradiation region 12 by the projector unit 8 is changed in response to the high-beam unit 6 turning ON under control by the lamp control ECU 9. In other words, it is changed from a shape in which the right-side pattern irradiation region 12 occupies a wide region of a horizontal trapezoidal shape including the overlap region 12a such as during low-beam mode, to a reduced shape not overlapping the high-beam irradiation region 10 without the overlap region 12a. The reduction of the right-side pattern irradiation region 12 can decrease the power consumption due to being realized by setting the number of light emitting elements turned ON in the projector unit 8 to more limited number than when turning ON all.

During either of the aforementioned low-beam mode time and high-beam mode time, in the right-side pattern irradiation region 12, the pattern irradiation light is irradiated in a bright/dark mixed irradiation pattern in which the bright regions 13 and dark regions 14 are alternately repeated as shown in FIG. 6 from the projector unit 8. The bright/dark mixed irradiation pattern of FIG. 6 in particular is a sloped rhombus lattice irradiation pattern 15 by the mesh design bright regions 13 of a sloped rhombus lattice and the dark regions 14 surrounded by these bright regions 13.

With the right-side pattern irradiation region 12, the bright regions 13 and dark regions 14 of the bright/dark mixed irradiation pattern dynamically move according to the vehicle speed in the front/rear direction of the vehicle 2. In other words, the bright/dark mixed irradiation pattern exhibits the appearance of a moving picture flowing in the front/rear direction of the vehicle 2.

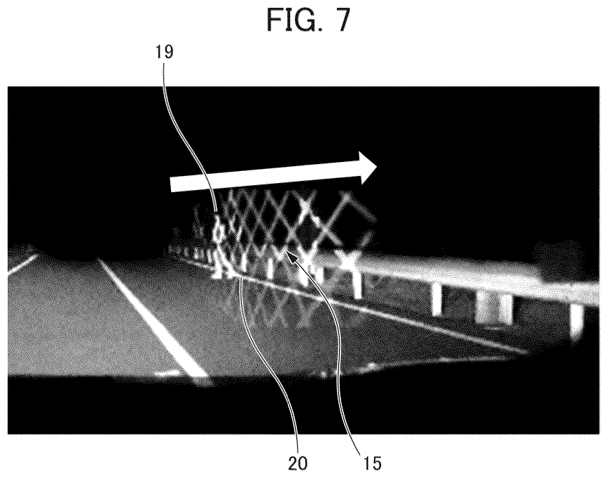

FIG. 7 is a view showing an aspect of irradiating the driving field of view at nighttime from the front windshield of the vehicle 2 with the vehicle lighting device 1 of the present embodiment. In FIG. 7, the same reference numbers are attached to corresponding parts with FIG. 6. In the driving field of view of FIG. 7, the sloped rhombus lattice irradiation pattern 15, which is the bright/dark mixed irradiation pattern of FIG. 6, is irradiated in a moving picture flowing as indicated by the arrow toward the right side of the roadside.

In the driver of the vehicle 2, a sight-induced self-motion perception is evoked by the bright/dark mixed irradiation pattern moving so as to flow in the front/rear direction of the vehicle 2 as mentioned above. The flow of the bright/dark mixed irradiation pattern is slower than the vehicle speed, and when viewing so as to come towards the vehicle 2 as in FIG. 7, the driver is guided to act to decelerate the vehicle 2. Contrary to the case of FIG. 7, when viewing so that the flow of the bright/dark mixed irradiation pattern overtakes the vehicle 2, the driver is guided to act to accelerate the vehicle 2 so as to catch up with the flow of the bright/dark mixed irradiation pattern.

It should be noted that the bright/dark mixed irradiation pattern from the projector unit 8 is a sloped rhombus lattice pattern as shown in FIG. 6; therefore, the presence of the pedestrian 19 on the roadside 20 is easily recognized from the driver, by the visual characteristic of humans. Even under adverse conditions such as nighttime and rainy weather, it is possible to improve overlooking of pedestrians 19 by the driver.

Herein, the dynamic movement between the bright regions 13 and dark regions 14 of the right-side pattern irradiation region 12 is realized by the DLP-type projector unit 8 being driven, for example, under the control by the lamp control ECU 9. In this case, the lamp control ECU 9 drives the projector unit 8 based on the output of a situation recognition device 50 that recognizes a situation prompting a deceleration action or acceleration action to the driver of one's own vehicle, and obtains an output corresponding to this recognition.

The situation recognition device 50 is configured to include the camera 16, speedometer 17, car navigation system 18, etc. In more detail, the situation recognition device 50 is configured by one or a plurality among the camera 16, speedometer 17 and car navigation system 18 cooperating with a functional part related to situation recognition of the lamp control ECU 9 to which the outputs from these are supplied. In addition, a drive function part governing driving of the high-beam unit 6, low-beam unit 7 and projector unit 8 of the lamp control ECU 9 configures a controller of the present embodiment.

In the following explanation, the functional part related to situation recognition of the lamp control ECU 9 is simply called lamp control ECU 9 as appropriate. The lamp ECU 9 acquires the value of vehicle speed of the vehicle 2 by calculation based on data related to the imaging field of view supplied from the camera 16, or acquires the value of vehicle speed of the vehicle 2 from the speedometer 17. The lamp control ECU 9 interprets data related to road signs within the imaging field of view supplied from the camera 16, and acquires the value of the speed limit of the road on which the vehicle 2 is traveling. Alternatively, the lamp control ECU 9 obtains the value of the speed limit of the road on which the vehicle 2 is traveling, based on data supplied from the car navigation system 18.

The functional part related to situation recognition of the lamp control ECU 9 compares the value of vehicle speed of the vehicle 2 acquired as mentioned above, and the value of the speed limit of the road on which the vehicle 2 is traveling, and generates an output that indicates whether or not the vehicle speed at the current time is appropriate. The output of the functional part related to situation recognition of the lamp control ECU 9 corresponds to the output of the situation recognition device 50.

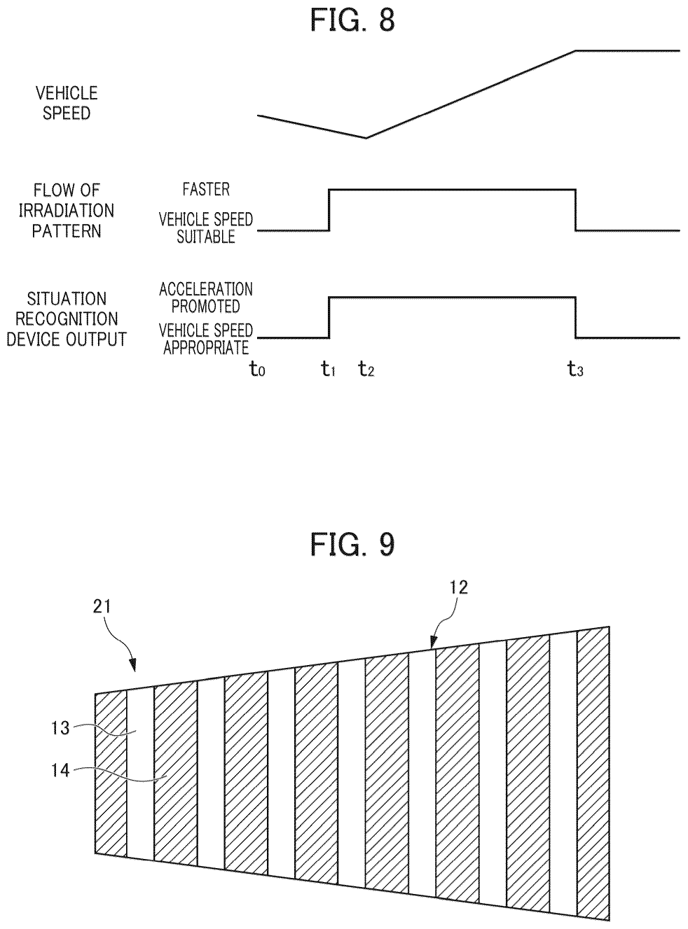

FIG. 8 is a timing chart showing operation of the vehicle lighting device 1. In the time interval from time t0 to t1, the value of the vehicle speed of the vehicle 2 acquired by the functional part related to situation recognition of the lamp control ECU 9 is appropriate compared to the value of the speed limit of the road on which the vehicle 2 is traveling. In other words, the vehicle speed of the vehicle 2 is roughly equal to the speed limit. Therefore, from time t0 to t1, the output of the situation recognition device 50 is a low level, for example, corresponding to “vehicle speed appropriate”. When the output of the situation recognition device 50 is “vehicle speed appropriate”, the aforementioned drive function part of the lamp control ECU 9 drives the projector unit 8 so that the flow of the irradiation pattern becomes “vehicle speed suitable”. In the case of the flow of the irradiation pattern being “vehicle speed suitable”, the driver is not prompted any action of acceleration or deceleration.

In the time interval after reaching time t1 until time t3, the value of the vehicle speed of the vehicle 2 acquired by the functional part related to situation recognition of the lamp control ECU 9 is an insufficient state compared to the value of the speed limit of the road on which the vehicle 2 is traveling. In other words, it is a state in which there is concern over the vehicle speed declining as in the aforementioned sag section, and causing a traffic jam. Therefore, from time t1 to t3, the output of the state recognition device 50 assumes a high level, for example, corresponding to “acceleration promoted”. When the output of the situation recognition device 50 is “acceleration promoted”, the aforementioned drive function part of the lamp control ECU 9 drives the projector unit 8 so that the flow of the irradiation pattern enters a “faster” state. In the time interval in which the flow of the irradiation pattern is in the “faster” state, the speed of the flow of the irradiation pattern exceeds the vehicle speed of the vehicle 2. For this reason, the flow of the irradiation pattern seems to overtake one's own vehicle during travel from the side of the driver. Therefore, the driver is prompted an acceleration action so as to catch up with the flow of the irradiation pattern.

It should be noted that, even if the flow of the irradiation pattern immediately transitions to the “faster” state at time t1, the driver delays by the reaction time until time t2 and takes the acceleration action. For this reason, the vehicle speed starts to rise from time t2. The driver continues the acceleration action from time t2 and later, and when reaching time t3, the value of the vehicle speed reaches the appropriate value. Therefore, the output of the situation recognition device 50 restores the low level corresponding to “vehicle speed appropriate”. In addition, the aforementioned drive function part of the lamp control ECU 9 drives the projector unit 8 so that the flow of irradiation pattern enters the “vehicle speed suitable” state. In the case of being “vehicle speed suitable”, the driver maintains the vehicle speed at this time.

With the vehicle lighting device 1 of the present embodiment, the subject of the action changing the vehicle speed according to the speed of the flow of the irradiation pattern irradiated from the projector unit 8 is the driver of the vehicle 2. In other words, the driver consciously takes an action for acceleration or deceleration, and the actual vehicle speed of the vehicle 2 changes so as to assume an appropriate value by this action. Therefore, no inconvenience arises from the driver feeling discomfort due to an unintended change in vehicle speed.

According to the vehicle lighting device 1 of the present embodiment, the following effects are exerted.

(1) With the vehicle lighting device 1, the situation recognition device 50 configured by one or a plurality among the camera 16, speedometer 17 and car navigation system 18 cooperating with a functional part related to situation recognition of the lamp control ECU 9 to which outputs of these are supplied, recognizes as having reached a situation where prompting a deceleration action or acceleration action to the driver of one's own vehicle is required, and emits an output corresponding to this recognition. In response to this output, a controller configured by a drive function part governing driving of the high-beam unit 6, low-beam unit 7 and projector unit 8 in the lamp control ECU 9 controls the projector unit 8 which is the pattern irradiation part so that the bright regions 13 and dark regions 14 of the pattern irradiation light move in the front/rear direction of the vehicle 2. For this reason, the driver is prompted by the flow of the irradiation pattern from the pattern irradiation part, and is guided to an action of accelerating or decelerating the vehicle 2. On the other hand, the bright/dark mixed irradiation pattern from the projector unit 8 is a bright/dark mixed irradiation pattern in which the bright regions 13 and dark regions 14 are alternately repeated; therefore, the presence of the pedestrian 19 on the roadside 20 is easily recognized from the driver by the visual characteristic of humans. Even under adverse conditions such as nighttime and rainy weather, it is possible to improve overlooking of the pedestrian 19 by the driver.

(2) With the vehicle lighting device 1, based on the output corresponding to recognition of the situation recognition device 50, the controller configured by the drive function part governing driving of the high-beam unit 6, low-beam unit 7 and projector unit 8 in the lamp control ECU 9 controls the projector unit 8 so as to change the speed at which the irradiation pattern of irradiation light moves in the front/rear direction of the vehicle. For this reason, the driver perceives the change in speed of flow of the irradiation pattern, and is prompted to adjust the vehicle speed so as to become the appropriate degree.

Although an embodiment of the present invention has been explained above, the present invention is not to be limited thereto. The configurations of detailed parts may be modified as appropriate within the scope of the gist of the present invention. For example, the irradiation pattern of irradiation light by the projector unit 8 is not limited to the rhombus lattice irradiation pattern 15 by the bright regions 13 of mesh design of the sloped rhombus lattice, and the dark regions 14 surrounded by these bright regions 13. In other words, the irradiation pattern of irradiation light by the projector unit 8 may be a stripe irradiation pattern 21 which is a vertical stripe pattern in which the bright regions 13 and dark regions 14 alternately align as shown in FIG. 9.

### EXPLANATION OF REFERENCE NUMERALS

1 vehicle lighting device
2 vehicle
3 test screen
4 left-side headlight unit
5 right-side headlight unit
6 high-beam unit
7 low-beam unit
8 projector unit (pattern irradiation part)
9 lamp control ECU
10 high-beam irradiation region (upper irradiation region)
11 low-beam irradiation region (lower irradiation region)
12 right-side pattern irradiation region (lateral irradiation region)
12a overlap region
13 bright region
14 dark region
15 rhombus lattice irradiation pattern
16 camera
17 speedometer
18 car navigation system
19 pedestrian
20 roadside
21 stripe irradiation pattern
50 situation recognition device

What is claimed is:

1. A vehicle lighting device comprising:
a pattern irradiation part which irradiates an irradiation region on a side of a travel path of one's own vehicle by a bright/dark mixed irradiation pattern in which bright regions and dark regions are alternately repeated;
a situation recognition device which recognizes a situation prompting a deceleration action or acceleration action to a driver of one's own vehicle, and obtains an output corresponding to the recognition; and
a controller which controls the pattern irradiation part so that bright regions and dark regions of the pattern irradiation light move in a front/rear direction of the vehicle, based on the output of the situation recognition device.

2. The vehicle lighting device according to claim 1, wherein the controller controls the pattern irradiation part so as to change a speed at which the bright regions and dark regions of the irradiation pattern move.
